(19) United States
(12) Patent Application Publication
(10) Pub. No.: US 2024/0386227 A1
(43) Pub. Date: Nov. 21, 2024

(54) APPARATUS AND METHOD FOR USING A PRODUCT HAVING AN IN-USE EXPIRY DATE

(71) Applicant: CHIESI FARMACEUTICI S.P.A., Parma (IT)

(72) Inventors: Charles POTTER, PARMA (IT); Alan TWEEDIE, PARMA (IT)

(21) Appl. No.: 18/704,352

(22) PCT Filed: Nov. 8, 2022
(86) PCT No.: PCT/EP2022/081142

§ 371 Date: Apr. 24, 2024

(30) Foreign Application Priority Data
Nov. 8, 2021 (EP) 21207013.0

(51) Int. Cl. G06K 7/14; G06Q 30/018; G09F 3/00

(52) U.S. Cl. CPC G06K 7/1417; G06Q 30/018; G09F 3/0297

(57) ABSTRACT

An apparatus for using a product having an in-use expiry date includes a portable electronic device and a label or tag of the product including a machine-readable code. An application loaded in the portable electronic device or in a remote location is configured for: receiving and optionally storing data of the product and a date of reading when reading devices read the machine-readable code at the date of reading and, if the machine-readable code has been read for the first time after manufacturing the product, then: calculating and storing an in-use expiry date from the date of reading and an in-use life period and/or starting an in-use expiry counter. An alert is enabled as a function of the in-use expiry date and/or of the in-use life period, so that the portable electronic device issues the alert when the in-use expiry date is reached or approaching or when the in-use life period is elapsed or about to elapse.

### TECHNICAL FIELD OF THE INVENTION

The present invention relates to an apparatus and a method for using a product having an in-use expiry date. In particular, the present invention aims to make safer and more effective the use of products that, by their nature, are expected to lose at least in part their properties (e.g. sterility) and/or to perish over time, such as, but not limited to, medicaments, cosmetics or foods, especially if placed in contact with the external environment.

### BACKGROUND ART

Products that change their properties when exposed to environmental conditions (i.e. moisture and/or temperature and/or light and/or pressure) are widely known. These products, after manufacturing and/or packaging, are usually kept in a protected environment during distribution and/or storage and before starting use and/or consumption.

For instance, food items which are sold in sealed packages or containers are known. The user opens the sealed package or container (e.g. a jar of jam) to start eating/drinking the product but, often, the consumption takes some days and the product starts losing its properties and perishing faster than when conserved in the protected environment of the package or container. Other known food items are distributed and stored in refrigerators and, once sold, they are not kept in the refrigerator but at room temperature and start perishing faster when exposed to normal environmental conditions.

These considerations apply to also some medicaments and cosmetic products, like drug-releasing patches, contact lens cleaning solutions, eye-drop medications, cosmetic creams or lotions for skincare or haircare, etc., For instance, contact lens cleaning solution, once open, is no longer sterile and should not be used for extended periods due to the risk of the solution becoming infected and therefore causing an infection in the eye; drug-releasing patches are sold in sealed packages containing several patches and the user opens the package when using a first patch while the other remain in the open package; eye-drop medications, cosmetic creams or lotions are sold in bottles, jars or tubes and the user removes the cap or cover when using the eye-drop medication, cosmetic cream or lotion for the first time. The same considerations may apply to other products, such as chemical products for building or industry, like paints, adhesives, sealants, etc.

All these products may have an expiry date which is generally printed on the packaging of the product or printed on the product at the time of manufacturing and/or packaging the product and refers to the product kept in the protected environment.

Since these products may be affected by the environmental conditions, the above mentioned expiry date may be no longer valid from the time the product is removed from the protected environment (e.g. when the packaging is opened for the first time or the product is removed from a refrigerator and kept at room temperature). Therefore, the user does not know the actual expiry date when the product is in-use. This actual expiry date may be referred to as “in-use expiry date” of the product, i.e. the date calculated from the time the product is first exposed to the environmental conditions. Once the in-use expiry date has passed, using or taking said product is not recommended and/or may be not effective and/or may be harmful and therefore the user may risk to use a product which is no longer suitable for use/consumption or to throw away or dispose of the product when it is still usable/consumable.

### SUMMARY

It is therefore an object of the present invention to eliminate the above drawbacks. It is an object of the present invention to provide a way of optimizing the use/consumption of a product with an expiry date so that it is not thrown away too soon or used when no longer effective.

Especially, it is object of the present invention to provide an apparatus and a method of advising the user not to use/consume the product after said product has passed the in-use expiry date. Exceeding the expiry date may be more or less critical depending on the type of product. Indeed, loss of sterility and potential infection with a contact lens solution or use of some cosmetics after in-use expiry or eating some foods after in-use expiry may lead to harm to the user. Using bathroom sealant or paint when it is not effective may be costly and annoying but may not cause physical harm to the user.

At least one of the above objects is substantially achieved by an apparatus and a method for using a product having an in-use expiry date according to one or more of the appended claims and/or of the following aspects.

Aspects of the invention are disclosed in the following.

In accordance with a 1^{st} independent aspect, an apparatus for using a product having an in-use expiry date, comprises:
at least one label or tag comprising a machine readable code comprising or linked to data of a respective product contained in an enclosure, wherein the label or tag is fixed to the product and/or contained in or attached to the enclosure, wherein the data of the product comprise an in-use life period ΔT_{in_use} of said product;
a portable electronic device comprising an electronic control unit and reading devices configured for reading the data of the product from the machine readable code;
an application loaded in the electronic control unit or in a remote location, optionally accessed over a network connection (e.g. a web based application) and configured for performing the following procedure:
   receiving and optionally storing the data of the product and a date of reading Tread when the reading devices read the machine readable code at said date of reading Tread and, if said data of the product are new data indicating that the machine readable code has been read for the first time after manufacturing the product, then:
   calculating and storing an in-use expiry date Texp_{in_use} from the date of reading Tread and the in-use life period ΔT_{in_use} as Texp_{in_use}=Tread+ΔT_{in_use} and/or starting an in-use expiry counter;
   enabling at least one alert as a function of the in-use expiry date Texp_{in_use} and/or of the in-use life period ΔT_{in_use}, so that the portable electronic device issues said at least one alert when the in-use expiry date Texp_{in_use} is reached and/or is approaching or when the in-use life period ΔT_{in_use} is elapsed or is about to elapse.

In a 2^{nd} independent aspect, a method for using a product having an in-use expiry date, comprises:
reading and optionally storing, through reading devices of a portable electronic device and from a machine readable code of a label or tag fixed to a product and/or contained in or attached to an enclosure containing the product, data of the product and a date of reading Tread; wherein the data of the product comprise an in-use life period ΔT_{in_use} of the product; and, if at least one of said data of the product is new indicating that the machine readable code has been read for the first time after manufacturing the product, then:
calculating and storing an in-use expiry date Texp_{in_use} from the date of reading Tread and the in-use life period ΔT_{in_use} as Texp_{in_use}=Tread+ΔT_{in_use} and/or starting an in-use expiry counter;
enabling at least one alert as a function of the in-use expiry date Texp_{in_use} and/or of the in-use life period ΔT_{in_use};
issuing, through the portable electronic device, said at least one alert when the in-use expiry date Texp_{in_use} is reached or is approaching and/or when the in-use life period ΔT_{in_use} is elapsed or is about to elapse.

In a 3^{rd} independent aspect, an application for managing a product having an in-use expiry date is loaded or is configured to be loaded in an electronic control unit of a portable electronic device or in a remote location; said application is configured for performing the following procedure:
receiving and optionally storing data of a product and a date of reading Tread when reading devices of the portable electronic device read a machine readable code at said date of reading Tread, wherein the data of the product comprise an in-use life period ΔT_{in_use} of the product; and, if at least one of said data of the product is new indicating that the machine readable code has been read for the first time after manufacturing the product, then:
calculating and storing an in-use expiry date Texp_{in_use} from the date of reading Tread and the in-use life period ΔT_{in_use} as Texp_{in_use}=Tread+ΔT_{in_use} and/or starting an in-use expiry counter;
enabling at least one alert as a function of the in-use expiry date Texp_{in_use} and/or of the in-use life period ΔT_{in_use}, so that the portable electronic device issues said at least one alert when the in-use expiry date Texp_{in_use} is reached and/or is approaching or when the in-use life period ΔT_{in_use} is elapsed or is about to elapse.

The invention helps the user not to use the product after the in-use expiry date. Indeed, only when the product is first removed from the protected environment (e.g. when the packaging is opened for the first time or the product is removed from a refrigerator and kept at room temperature), the in-use expiry counter/clock and the countdown to the in-use expiry date will be started. This way, the invention helps the user to avoid using or consuming the product after said product has passed the in-use expiry date.

The invention provides also further advantages and technical effects. For instance, the invention allows to optimize the use/consumption of the product so that it is not thrown away too soon or used when no longer effective.

The invention allows also to ensure that the product is supplied in time before stocks run out or become unusable because the in-use expiry date of all the stocks have passed. The invention may also allow for automatic reordering of the product in the weekly shopping in advance of the expiry date to ensure the user always has the product available.

In a 4th aspect according to at least one of the preceding aspects, if said data of the product are new data indicating that the machine readable code has been read for the first time after manufacturing the product, the date of reading Tread is recorded and/or labeled as date of first use of the product after manufacturing (i.e. when the product is first exposed to the environmental conditions, e.g. temperature and/or moisture and/or light and/or pressure and/or other contamination).

In a 5th aspect according to at least one of the preceding aspects, enabling at least one alert comprises: enabling a final alert.

In a 6th aspect according to the preceding aspect, issuing said at least one alert comprises: issuing the final alert when the in-use expiry date Texp_{in_use} is reached and/or when the in-use life period ΔT_{in_use} is elapsed.

In a 7th aspect according to at least one of the preceding aspects, enabling at least one alert comprises: enabling at least one pre-alert.

In an 8th aspect according to the preceding aspect, issuing said at least one alert comprises: issuing the at least one pre-alert before reaching the in-use expiry date Texp_{in_use} and/or before that the in-use life period ΔT_{in_use} is elapsed.

This enables alerts to be given to the user when the product is reaching the end of its in-use life.

In a 9th aspect according to at least one of the preceding aspects, the data of the product further comprise an expiry date Texp.

In a 10th aspect according to the preceding aspect, the method comprises, or the application is configured for, comparing the expiry date Texp with the in-use expiry date Texp_{in_use} and issuing a further alert if the in-use expiry date Texp_{in_use} occurs after the expiry date Texp and/or if the in-use life period ΔT_{in_use} elapses after the expiry date Texp.

In this case, the user may immediately return the product to the shop and get another.

In a 11th aspect according to at least one of the preceding aspects, the data of the product comprise a unique identifier of the product.

In a 12th aspect according to the preceding aspect, the method comprises, or the application is configured for, associating the unique identifier to the date of reading Tread and/or to the in-use expiry date Texp_{in_use} and/or to the in-use life period ΔT_{in_use} to allow managing a plurality of products.

In a 13th aspect according to at least one of the preceding aspects, if the data of the product are identified as already read by the portable electronic device and/or are already present in the electronic control unit or in the remote location (i.e. are not new), then the method does not perform or the application is configured for not performing: reading and/or receiving and/or storing the date of reading Tread.

In a 14th aspect according to at least one of the preceding aspects, if the data of the product are identified as already read by the portable electronic device and/or are already present in the electronic control unit or in the remote location (i.e. are not new), then the method does not perform or the application is configured for not performing at least one of: calculating and storing the in-use expiry date Texp_{in_use}, enabling the at least one alert, issuing said at least one alert.

In a 15th aspect according to at least one of the preceding aspects, the method comprises or the application is configured for performing the following procedure: if the data of the product are identified as already read by the portable electronic device and/or are already present in the electronic control unit or in the remote location (i.e. are not new), then showing, through output devices of the portable electronic device, a status indicating that the machine readable code has already been read.

If the user has more than one product to manage, then the machine readable code can be read again to ensure the right product is being disposed of (i.e. it will recognise that a date of first use has already been stored/labeled for that product). In a 16th aspect according to at least one of the preceding aspects, the data of the product comprise further information on the product, for instance manufacturing site, manufacturing date, batch number, best storage conditions for the product (e.g. in fridge, in cool dry place, in the dark etc.). Other data may depend on the kind of product.

In a 17th aspect according to at least one of the preceding aspects, the method comprises or the application is configured for performing the following procedure: if the data of the product are identified as already read by the portable electronic device and/or are already present in the electronic control unit or in the remote location (i.e. are not new), then showing, through output devices of the portable electronic device, a remaining in-use life period ΔTᵣₑₘₐᵢₙ.

In a 18th aspect according to at least one of the preceding aspects, in addition to enabling at least one alert, the method comprises or the application is configured for performing the following procedure: enabling further notification and or links, like instructions for use, links to videos of how to use the product, disposal instructions, etc.

In a 19th aspect according to at least one of the preceding aspects, the method comprises or the application is configured for performing the following procedure:
receiving or selecting a parameter reflecting a region or country where the portable electronic device is located and/or where a user of the product lives and/or a time of year/season;
choosing, among the data of the product, the in-use life period ΔT_{in_use} for that region or country and/or the time of year/season.

In a 20th aspect according to at least one of the preceding aspects, the portable electronic device comprises a radio receiver and the method comprises or application is configured for performing the following procedure:
receiving from the radio receiver a parameter reflecting a region or country where the portable electronic device is located and/or a time of year/season;
choosing, among the data of the product, the in-use life period ΔT_{in_use} for that region or country and/or a time of year/season.

In a 21st aspect according to the previous aspect, the radio receiver is a GPS receiver or a receiver of mobile network (e.g. 3G, 4G, 5G) or a Bluetooth receiver or a Wi-Fi receiver.

Since in-use life period may depend on the region or country and/or time of year/season (e.g. due to temperature and/or humidity and/or pressure differences; some countries or regions are very hot in summer and much cooler in winter), this further function ensures the expiry is correct for the region or country of use and/or time of year/season.

In a 22nd aspect according to at least one of the preceding aspects, the enclosure delimits a controlled atmosphere environment.

In a 23rd aspect according to at least one of the preceding aspects, the enclosure comprises a sealed package, e.g. a pouch or a bag or a sack, or container, e.g. a jar or a can or a bucket or a bottle or a tube.

In a 24th aspect according to at least one of the preceding aspects 1 to 22, the enclosure comprises a device delimiting a controlled atmosphere environment, like a refrigerator or a humidity and temperature stability chamber, etc.

In a 25th aspect according to at least one of the preceding aspects, reading is performed after opening for the first time the enclosure and/or after removing for the first time the product from the enclosure.

In a 26th aspect according to at least one of the preceding aspects, the product is a perishable product or a sterile product while it is in its sealed package.

In a 27th aspect according to at least one of the preceding aspects, the product is a medicament device (e.g. an inhaler, like a powder inhaler (DPI) or a pressurized metered dose inhaler (pMDI) or a soft mist inhaler (SMI), drug-releasing patches, contact lens cleaning solutions, an eye-drop medication, cough sweets) or a cosmetic product (e.g. a cosmetic cream or lotion for skincare or haircare) or a food item (e.g. jam, mayonnaise, sweets).

In a 28th aspect according to at least one of the preceding aspects 1 to 25, the product is a product for building or industry (e.g. paint, adhesive or sealant, cement or resin).

In a 29th aspect according to at least one of the preceding aspects, the label or tag comprises an optical code, like a QR code or a bar code, and the reading devices comprise an optical reader, like a camera.

In a 30th aspect according any of the preceding aspects 1 to 28, the label or tag is a tag RFID (Radio-frequency identification) and the reading devices comprise an RFID reader or the label or tag is a beacon BLE (Bluetooth low energy) and the reading devices comprise a BLE reader; optionally said label or tag also incorporates a “write function” and the portable electronic device comprises writing devices configured to write in said label or tag.

In a 31st aspect according to any of the preceding aspects, the portable electronic device is a smartphone.

In a 32nd aspect according any of the preceding aspects, the data of the product are contained in the machine readable code and/or in the portable electronic device.

In a 33rd aspect according to the preceding aspect, when the reading devices read the machine readable code at said date of reading Tread, the method comprises or the application is configured for performing the following procedure: reading the data of the product from the machine readable code.

In a 34th aspect according to any of the preceding aspects 1 to 33, the data of the product are contained in a remote location, optionally accessed over a network connection (e.g. a remote database).

In a 35th aspect according to the preceding aspect, when the reading devices read the machine readable code at said date of reading Tread, the method comprises or the application is configured for performing the following procedure:
reading an address of the remote location from the machine readable code;
connecting to the remote location and retrieving said data of the product from the remote location;
optionally storing said data of the product in the portable electronic device or in the label or tag if said label or tag also incorporates a “write function”, such as a tag RFID or a beacon BLE.

In a 36th aspect according to any of the preceding aspects, in order to discern if the data of the product are new data, the method comprises or the application is configured for performing the following procedure: comparing at least one of the data of the product with at least one of the data already stored of other products previously read.

In a 37th aspect according to the preceding aspect and to aspect 11 or 12, it is provided for comparing the unique identifier of the product with unique identifiers already stored of other products previously read.

In a 38th aspect according to any of the previous aspects, the in-use expiry date Texp_{in_use} is stored in the portable electronic device or in a remote location, optionally accessed over a network connection (e.g. a remote database), or in the label or tag if said label or tag also incorporates a “write function”, such as a tag RFID or a beacon BLE.

In a 39th aspect according to any of the previous aspects, if the label or tag is a beacon (e.g. BLE), then it could automatically emit a signal when it is first used. This signal may be picked up in a home environment or home hub which could store the in-use expiry date Texp_{in_use} in a remote location.

In a 40th aspect according to any of the previous aspects, the method comprises or the application is configured for adjusting the date of reading Tread or date of first use and/or to manually enter, through the portable electronic device, the date of reading or date of first use. This may be useful if the user forgets to read the machine readable code when the product is first used.

In a 41st aspect according to any of the preceding aspects, the apparatus comprises also the product or products and/or the enclosure or enclosures.

Further features will appear in greater detail in the detailed description of preferred, but not exclusive, embodiments of an apparatus and a method for using a product having an in-use expiry date according to the present invention.

### DESCRIPTION OF THE DRAWINGS

FIG. 1 shows an apparatus for using a product having an in-use expiry date, according to the present invention, with a number of products;

FIG. 2 shows the apparatus of FIG. 1 with other products;

FIG. 3 is a schematic representation of part of the apparatus of FIGS. 1 and 2;

FIG. 4 is a flow chart of a method according to the invention.

### DETAILED DESCRIPTION

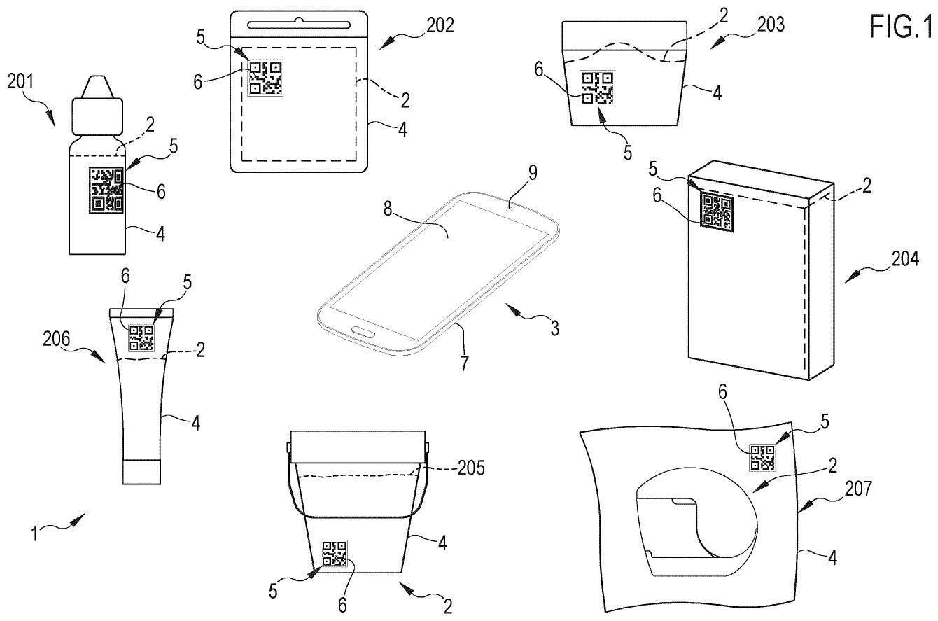

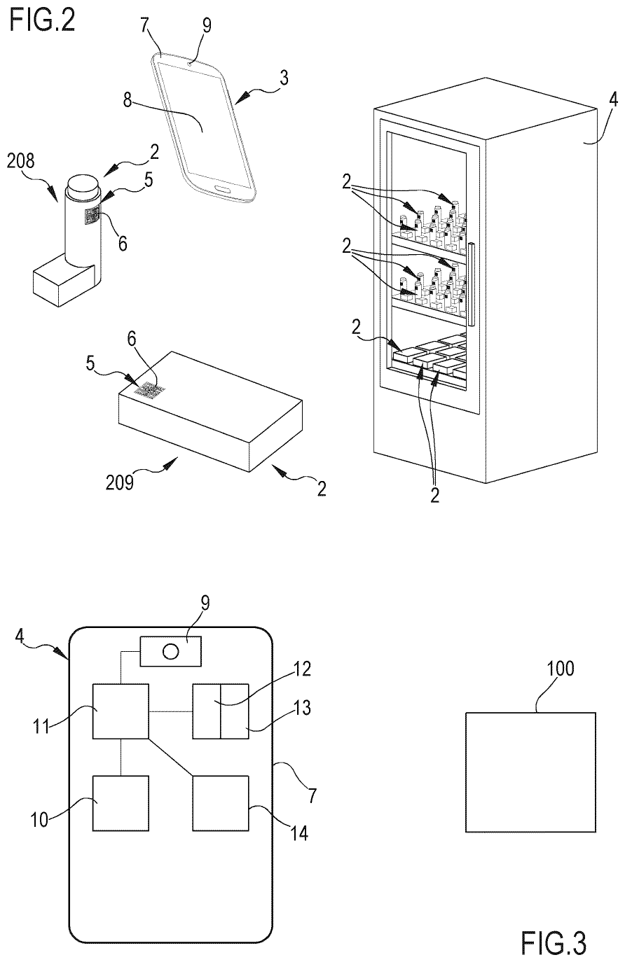

With reference to the appended drawings, FIGS. 1 and 2 show an apparatus 1 for using a product 2 having an in-use expiry date. The apparatus 1 shown for illustrative and non-limiting purposes in FIGS. 1 and 2 comprises a smartphone 3, i.e. a portable electronic device, a software application (App) loaded in the smartphone 3 and configured for use with a plurality of different products 2 contained in enclosures 4. The products 2 may be perishable products, like food or medicines, or a sterile product while it is in its sealed package.

The products 2 of FIG. 1 are each contained in a respective enclosure 4. For instance, said products 2 of FIG. 1 comprise an eye-drop medication or a contact lens cleaning solution in a bottle 201, a plurality of drug-releasing patches in an envelope 202, a cosmetic cream or lotion in a jar 203, some cement in a sack 204, some paint in a bucket 205, mayonnaise in a tube 206, a dry powder inhaler (DPI) in a pouch 207. The bottle, the envelope, the jar, the tube and the pouch are the enclosures 4 for the respective products (eye-drop medication, drug-releasing patches, paint, cement, mayonnaise, dry powder inhaler) and said enclosures 4 prevent the products to come into contact with the atmosphere environment.

The products 2 of FIG. 2 are all contained in a single enclosure 4, which is a refrigerator. These products may comprise pressurized metered dose inhalers 208 and packets of cough sweets 209. In this case, the refrigerator prevents the products 2 to come into contact with the atmosphere environment.

The enclosures 4 delimit a controlled atmosphere environment, meaning that the product or products inside each enclosure is/are protected from ambient moisture and/or temperature and/or light and/or pressure before the user starts using it/them. The apparatus further comprises a label or tag 5 comprising a QR code 6 (i.e. a machine readable code) applied to the product 2 (as in FIG. 2) or to the enclosure 4 (as in FIG. 1). The QR code 6 comprises or is linked to data of the product 2 as will be explained hereafter.

The smartphone 3 is also per se known and comprises a casing 7 with a display 8 and contains (FIG. 5) a camera 9 (reading device), a memory 10, an electronic control unit 11, a radio receiver 12, a radio transmitter 13 and a GPS receiver 14. The electronic control unit 11 is operationally connected to the camera 9, to the memory 10, to the radio receiver 12, to the radio transmitter 13 and to the GPS receiver 14 to properly manage the operations of the smartphone 3.

The radio receiver 12 and the radio transmitter 13 are configured to communicate with a cellular or mobile network (e.g. 3G, 4G or 5G network).

The GPS receiver 14 is configured to receive signals from satellites of the GPS system.

The smartphone 3 may be also provided with a Bluetooth transmitter/receiver and a Wi-Fi transmitter/receiver, not shown in the annexed figures.

The software application (App) is configured for managing one product 2 or more products 2. The application is loaded in the smartphone 3, e.g. stored in the memory 10 of the smartphone 3, and the electronic control unit 11 is configured to run said application and also to perform the method according to the invention.

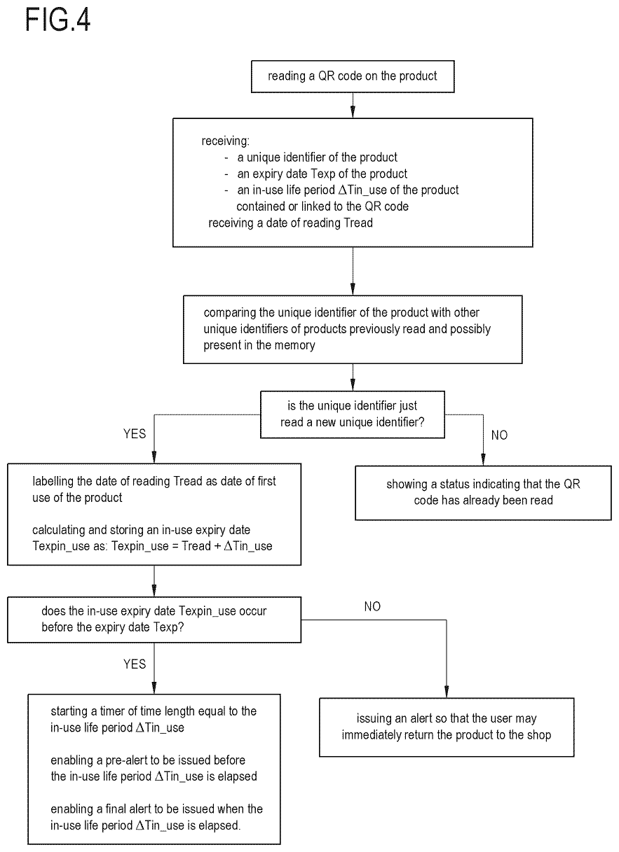

Referring to the flowchart of FIG. 4, the application is configured to read, through the camera 9, the QR code 6 and to receive and store the data of the product 2 contained or linked to the QR code.

For instance, in one embodiment, the data of the product 2 may be contained in the QR code 6 or, in another embodiment, said data may be contained in a web-accessible remote database 100 and the QR code 6 contains a web address of said remote database 100, so that, when the user points the camera 9 of the smartphone 3 towards the QR code 6 while the application is running, the application retrieves said data from the remote database 100 and may save them in the memory 10.

The data of the product 2 comprise an in-use life period ΔT_{in_use} of the product 2, i.e. a period starting from the hypothetical first use of the product 2, when the product 2 is first exposed to normal environmental conditions, e.g. room temperature and/or moisture and/or light and/or pressure and/or non-sterile conditions.

For instance, the drug-releasing patches 202 of FIG. 1 are stored in the envelope (i.e. in the enclosure 4 delimiting the controlled atmosphere environment) during distribution and storage at the pharmacy and the in-use life period ΔT_{in_use} will typically start from the first opening of the envelope.

For instance, the paint 205 of FIG. 1 is stored in the bucket (i.e. in the enclosure 4 delimiting the controlled atmosphere environment) during distribution and storage at the shop and the in-use life period ΔT_{in_use} will typically start from the first opening of the bucket.

For instance, the mayonnaise 206 of FIG. 1 is sold in the tube (i.e. in the enclosure 4 delimiting the controlled atmosphere environment) during distribution and storage at the market and the in-use life period ΔT_{in_use} will typically start from the first opening of the tube.

For instance, the pressurized metered dose inhalers 208 of FIG. 2 are kept in a refrigerator (i.e. in the enclosure 4 delimiting the controlled atmosphere environment) during distribution and storage at the pharmacy and the in-use life period ΔT_{in_use} will typically start from the extraction from the refrigerator. The in-use life period ΔT_{in_use} of a product 2 is known to the manufacturer, depends on the product 2 and may be for instance some days, weeks or months, or even longer. The in-use life period ΔT_{in_use} is, of course, only guaranteed if the user respects the recommendations for use and storage of the product 2.

The in-use life period ΔT_{in_use} is known and is part of the data of the product 2 but an in-use expiry date Texp_{in_use} calculated from the hypothetical first use is unknown when the product 2 is manufactured and/or packaged and cannot be part of the data of the product 2.

The data of the product 2 typically further include a unique identifier of the product 2, e.g. a serial number.

The data of the product 2 typically further include an expiry date Texp, i.e. an expiry date calculated from the date of manufacturing the product 2. Since the date of manufacturing is known, the expiry date Texp is part of the data of the product 2 in the QR code or in the remote database 100. The expiry date Texp is typically the expiry date of the product 2 if said product 2 is kept safe from normal environmental conditions, e.g., if the drug-releasing patches 202 are kept in the unbroken envelope or the paint 205 is kept in the unopened bucket or the pressurized metered dose inhalers 208 are kept in the refrigerator. Also this expiry date Texp is known to the manufacturer and depends on the kind of product 2.

According to embodiments, the database 100 includes a plurality of expiry dates Texp and/or in-use life periods ΔT_{in_use}, each linked to one or more geographical regions or countries, since the expiry date Texp and the in-use life period ΔT_{in_use} may depend on the region or country due, e.g., to temperature and/or humidity and/or pressure differences.

The application is configured for receiving a parameter reflecting the region or country where the smartphone 3 is located and/or the user lives and choosing the expiry date Texp and/or the in-use life period ΔT_{in_use} for that region or country. Said parameter reflecting the region or country may be entered by the user or retrieved by the application from the cellular or mobile network and/or from the GPS system. The application may also be configured for receiving a parameter reflecting the time of year/season when the product 2 is used, since some countries or regions are very hot in summer and much cooler in winter and the climatic conditions greatly affect the products 2.

The data of the product 2 may also include further information and/or links (e.g. web addresses) to retrieve such information, such as e.g. manufacturing site, manufacturing date, batch number, best storage conditions, etc., and other data depending on the product 2. For instance, the data of the drug-releasing patches 202 include the formulation of the medicament and the instructions for applying the patch; the data of the paint 205 include instructions for use; the data of the pressurized metered dose inhaler 208 include drug formulation, dose, link to videos of how to use the device.

According to the method for using a product of the invention, the user purchases the product 2 and, after opening the enclosure 4 and/or removing for the first time the product 2 from the enclosure 4, he/she points the camera 9 of the smartphone 3 towards the QR code 6 while the application is running and reads for the first time the QR code 6.

The application is configured for:
receiving and optionally storing a date of reading Tread, i.e. the date on which the QR code is read;
comparing the unique identifier of the product 2 with other unique identifiers of products 2 previously read and possibly present in the memory 10.

If the unique identifier just read is the first read or is different from the other unique identifiers, i.e. it is a new unique identifier indicating that the QR code has been read for the first time after manufacturing the product 2, then:
labeling and storing the date of reading Tread as date of first use of the product 2 after manufacturing associated to the unique identifier;
calculating and storing an in-use expiry date Texp_{in_use} from the date of reading Tread and the in-use life period ΔT_{in_use} as “Texp_{in_use}=Tread+ΔT_{in_use}” and/or starting an in-use expiry counter, i. e. a timer of time length equal to the in-use life period ΔT_{in_use};
comparing the expiry date Texp with the in-use expiry date Texp_{in_use} and, if the in-use expiry date Texp_{in_use} occurs after the expiry date Texp and/or if the in-use life period ΔT_{in_use} elapses after the expiry date Texp then issuing, through the smartphone 3, an alert (e.g. an audible or visual signal or vibration) so that the user may immediately return the product 2 to the shop and get another, otherwise:
enabling a pre-alert so that said pre-alert may be issued through the smartphone 3 (e.g. a message, an audible or visual signal or vibration) before reaching the in-use expiry date Texp_{in_use} and/or before the in-use life period ΔT_{in_use} is elapsed (e.g. some weeks or days before to alert the user when the product 2 is reaching the end of its in-use life);
enabling a final alert so that said final alert may be issued when the in-use expiry date Texp_{in_use} is reached and/or when the in-use life period ΔT_{in_use} is elapsed.

The application may also be configured for adjusting the date of reading Tread or date of first use and/or to manually enter, through the portable electronic device 3, the date of reading Tread or date of first use and this function may be useful if the user forgets to read the machine readable code 6 when the product 2 is first used and/or removed from its packaging.

The application may be also configured to enable further notification and or links. If the unique identifier just read is the same as one of the other unique identifiers in the memory 10, i.e. it is not a new unique identifier indicating that the QR code has already been read, then the steps disclosed above are not performed. Furthermore, the application may be configured for:
showing, through the display 8 or other output devices of the smartphone 3, a status (a message, an image, etc.) indicating that the QR code has already been read and a remaining in-use life period ΔTᵣₑₘₐᵢₙ of the product 2.

The application allows therefore to manage a plurality of products 2, of the same of different kinds, and ensures the correct product 2 is being disposed of when the final alert is issued.

According to embodiments, the application may be not loaded in the electronic control unit but is a web based application accessed over a network connection. According to other embodiments of the invention, other tags or labels 5 provided with a machine readable code 6 may be employed instead of the QR code, for instance, a bar code or a tag RFID (Radio-frequency identification) or a beacon BLE (Bluetooth low energy). Accordingly, the reader will be an optical reader (like the camera 15) or a RFID reader or a BLE reader. Since these kind of tags (RFID reader or a BLE reader) may incorporate a “write function”, the data of the product 2 and/or the in-use expiry date Texp_{in_use} may be stored in the tags. For this purpose, the portable control unit 3 comprises writing devices to write the data of the product 2 and/or the in-use expiry date Texp_{in_use} in the tags. If the label or tag is a beacon BLE, then it could automatically emit a signal when it is first used. This signal may be picked up in a home environment (e.g. Alexa™) or home hub which could store the in-use expiry date Texp_{in_use} in the cloud.

The tag or label 5 with the machine readable code 6 may be attached on the product 2, like in FIG. 2, on the enclosure 4, like in FIG. 1, but also on a sheet sold with the product 2 and/or inserted in the enclosure 4.

### LIST OF ELEMENTS

apparatus 1
product 2
portable electronic device 3
enclosure 4
label or tag 5
QR code 6
casing 7
display 8
camera 9
memory 10
an electronic control unit 11
radio receiver 12
radio transmitter 13
GPS receiver 14
remote database 100
eye-drop medication in a bottle 201
drug-releasing patches in an envelope 202
cosmetic cream or lotion in a jar 203
cement in a sack 204
paint in a bucket 205
mayonnaise in a tube 206
dry powder inhaler (DPI) in a pouch 207
pressurized metered dose inhalers 208
packets of cough sweets 209

1.-15. (canceled)

16. An apparatus for using a product having an in-use expiry date, the apparatus comprising:
at least one label or tag comprising a machine-readable code comprising or linked to data of a respective product contained in an enclosure, wherein the label or tag is i) fixed to the product and/or iia) contained in or iib) attached to the enclosure, wherein the data of the product comprise an in-use life period (ΔT_{in_use}) of said product;
a portable electronic device comprising an electronic control unit and reading devices configured for reading the data of the product from the machine-readable code;
an application loaded in the electronic control unit or in a remote location and configured for:
receiving and optionally storing the data of the product and a date of reading (Tread) when the reading devices read the machine-readable code at said date of reading;
if said data of the product are new data, thus indicating that the machine-readable code has been read for the first time after manufacturing the product, then:
calculating and storing an in-use expiry date (Texp_{in_use}) from the date of reading and the in-use life period as Texp_{in_use}=Tread+ΔT_{in_use} and/or starting an in-use expiry counter; and
enabling at least one alert as a function of the in-use expiry date and/or of the in-use life period, so that the portable electronic device issues said at least one alert i) when the in-use expiry date is reached or approaching or ii) when the in-use life period is elapsed or about to elapse.

17. The apparatus of claim 16, wherein the data of the product further comprise an expiry date and the application is configured for comparing the expiry date with the in-use expiry date and to issue a further alert i) if the in-use expiry date occurs after the expiry date and/or ii) if the in-use life period elapses after the expiry date.

18. The apparatus of claim 16, wherein:
the data of the product comprise a unique identifier of the product, and
the application is configured for associating the unique identifier to at least one of i) the date of reading, ii) the in-use expiry date, and iii) the in-use life period, to allow managing of a plurality of products.

19. The apparatus of claim 16, wherein the application is configured for:
if the data of the product are not new, showing, through output devices of the portable electronic device, i) a status indicating that the machine-readable code has already been read and/or ii) a remaining in-use life period.

20. The apparatus of claim 16, wherein the portable electronic device comprises a radio receiver and the application is configured for:
receiving from the radio receiver a parameter indicating i) a region or country where the portable electronic device is located and/or ii) a time of year or season;
choosing, among the data of the product, the in-use life period for said region or country and/or said time of year or season.

21. The apparatus of claim 16, wherein
the product is a medicament device, a cosmetic product, a food item, or a product for buildings or industry and
the enclosure delimits a controlled atmosphere environment.

22. The apparatus of claim 16, wherein the label or tag comprises a QR code, the portable electronic device is a smartphone and the reading devices comprise a camera.

23. A method for using a product having an in-use expiry date, comprising:
reading and optionally storing, through reading devices of a portable electronic device and from a machine-readable code of a label or tag i) fixed to a product and/or iia) contained in or iib) attached to an enclosure containing the product, data of the product and a date of reading (Tread); wherein the data of the product comprise an in-use life period (ΔT_{in_use}) of the product;
if at least one of said data of the product is new, thus indicating that the machine-readable code has been read for the first time after manufacturing the product, then:
calculating and storing an in-use expiry date (Texp_{in_use}) from the date of reading and the in-use life period as Texp_{in_use}=Tread+ΔT_{in_use} and/or starting an in-use expiry counter;
enabling at least one alert as a function of the in-use expiry date and/or of the in-use life period; and
issuing, through the portable electronic device, said at least one alert i) when the in-use expiry date is reached or approaching and/or ii) when the in-use life period is elapsed or about to elapse.

24. The method of claim 23, comprising:
comparing an expiry date, which is part of the data of the product, with i) the in-use expiry date and/or with ii) the in-use life period; and
issuing a further alert i) if the in-use expiry date occurs after the expiry date and/or ii) if the in-use life period elapses after the expiry date.

25. The method of claim 23, comprising:
associating a unique identifier of the product to at least one of the date of reading, the in-use expiry date, and the in-use life period to allow managing of a plurality of products.

26. The method of claim 23, comprising:
if the data of the product are not new, showing, through output devices of the portable electronic device, a status indicating that the machine-readable code has already been read.

27. The method of claim 23, comprising:
if the data of the product are not new, showing, through output devices of the portable electronic device, a remaining in-use life period.

28. The method of claim 23, further comprising:
receiving a parameter indicating at least one of i) a region or country where the portable electronic device is located, ii) a region or country where a user of the product lives, and iii) a time of year or season; and
choosing, among the data of the product, the in-use life period for said region, country and/or said time of year or season.

29. The method claim 23, wherein the enclosure delimits a controlled atmosphere environment and wherein reading is performed i) after opening for the first time the enclosure and/or ii) after removing for the first time the product from the enclosure.

30. The method of claim 23, wherein the product is a medicament device, a cosmetic product, a food item or a product for building or industry.
